(19) United States
(12) Patent Application Publication
(10) Pub. No.: US 2026/0068826 A1
(43) Pub. Date: Mar. 12, 2026

(54) DENSELY PLANTED COCONUT PALM GROVE WITH INCREASED YIELD

(71) Applicant: VIRIDIS ARBOR LLC, Verona, NJ (US)

(72) Inventor: Gary E. Abeles, Verona, NJ (US)

(73) Assignee: VIRIDIS ARBOR LLC, Verona, NJ (US)

(21) Appl. No.: 19/394,410

(22) Filed: Nov. 19, 2025

Related U.S. Application Data
(63) Continuation-in-part of application No. PCT/US24/27032, filed on Apr. 30, 2024.
(60) Provisional application No. 63/508,391, filed on Jun. 15, 2023.

(51) Int. Cl. A01G 17/00

(52) U.S. Cl. CPC A01G 17/005

(57) ABSTRACT

The density of coconut palms in a grove, and the resulting coconut yield per acre, is increased up to a factor of four by varying the heights of the leaf balls of the palms, and arranging the palms close together so that the leaf balls overlap without mutual interference. Adjacent palms can be of different varieties having differing heights, for example by combining tall, dwarf, and hybrid palms, and/or the grades at which adjacent palms are planted can be excavated and/or built up. The palms can be configured in a “checkerboard” arrangement where leaf ball heights alternate in aligned rows and columns, or in a “hexagonal” arrangement where rows of palms of alternating leaf ball height are staggered. Palm rows of uniform or staggered height can be planted on north-south terraces at successively higher grade up to an apex terrace, from which the terraces descend again in grade height.

### RELATED APPLICATIONS

This application a continuation in part of International Application No. PCT/US24/27032, filed Apr. 30, 2024. Application PCT/US24/27032 claims the benefit of U.S. Application No. 63/508,391, filed Jun. 15, 2023. Both of these applications are herein incorporated by reference in their entirety for all purposes.

### FIELD OF THE INVENTION

The invention relates to farming of tree-based produce, and more particularly to coconut farming.

### BACKGROUND OF THE INVENTION

Coconut palms grow in sandy soil where there is ample sun and rainfall. While the roots will generally grow outwards for up to 30 feet, they tend to stay near the surface, with 80% of the roots remaining within 30-90 cm from the surface (1-3 feet), and 94% of the roots remaining within 90-150 cm from the surface, (3-5 feet). The leaves of coconut palms are configured as leaf “balls” that spread outward from the top of the trunk of the palm in an approximately spherical pattern to a distance of as much as 9-10 feet in all directions. For taller varieties, the leaves occupy about the upper one third of the palm, while for shorter varieties the leaves occupy approximately the upper half of the palm.

With reference to FIG. 1, in a coconut farm, the coconut palms 100 are planted with their trunks 102 about 20 feet apart, so as to minimize interference between the leaf balls 104 of neighboring palms. However, this relatively wide spacing limits the number of palms that can be planted, and hence the number of coconuts that can be harvested, per acre of land.

What is needed, therefore, is a coconut palm grove configured to provide an increased yield of coconuts per acre of land.

### SUMMARY OF THE INVENTION

The present invention is a coconut palm grove configured to provide an increase yield of coconuts per acre of land. The grove is configured such that the coconut palms are spaced apart by a distance of than 20 feet. Interference between the leaf balls of adjacent palms is avoided by varying the heights of the leaf balls of adjacent palms, so that they at least partially overlap without interference. In embodiments, the spacing between palms is reduced from 20 feet to approximately 12 feet, allowing the leaf balls of the shorter palms to nearly touch the trunks of the neighboring taller palms. By reducing the inter-palm spacing by nearly a factor of 2, this approach can increase the yield of coconuts per acre by nearly a factor of 4. In other embodiments, the spacing between the palms is reduced from 20 feet to about 16 feet, resulting in a 50% increase in coconut yield per acre of land.

In embodiments, the heights of adjacent palms are varied, at least in part, by alternating the varieties of the coconut palms that are planted. For example, the leaf balls of “dwarf” varieties such as Malaysian or Fiji dwarf palms will generally fit entirely beneath the leaf balls of adjacent “tall” varieties such as Solomon Islands, Rennell, or Malaysian tall palms, thereby allowing the palms to be alternated in rows with a spacing of less than 20 feet.

In other embodiments, the heights of adjacent palms are varied, at least in part, by varying the grade of the ground on which the palms are planted, e.g. by some combination of excavating and/or building up the ground alternately, such that even palms of the same variety will differ in height. This approach can be used alone, or in combination with alternating the varieties of the palms. For example, alternating the grade beneath the palms can enable the leaf balls of tall palms to extend entirely above the leaf balls of adjacent hybrid palms that have an intermediate height between the tall and dwarf palm varieties. In addition, varying the grade height of the underlying ground can have the benefit of avoiding interference between the roots of adjacent palms. For example, by planting every other palm in a “recessed” location that is at least five feet below the planting heights of adjacent palms, interference between the leaf balls of adjacent palms can be avoided, while at the same time causing the roots of the palms planted in the excavated locations to extend at a depth that is well below the roots of the adjacent palms.

In some embodiments, the palms are arranged in a “checkerboard” pattern of rows and columns, with the leaf balls of the palms being alternated between two heights or “levels” in both the rows and the columns of the palms, and with each of the palms being surrounded by four nearest neighbor palms. For example, short and tall varieties of palms can be alternated in both their rows and columns, or the height of the grade beneath palms of the same variety can be alternated in both their rows and columns, by building up the ground under every other palm and/or lowering the grade height beneath every other palm. In these “checkerboard” embodiments, the palms can be located as closely as 14 to 16 feet apart in both the rows and the columns, thereby nearly increasing the coconut yield by about 50%. In similar embodiments, the palms are arranged in a staggered “hexagonal” pattern with each of the palms being surrounded by six nearest neighbor palms. This approach enables the palms to be spaced as closely as 12 feet, nearly quadrupling the yield of coconuts per acre.

When configured in a checkerboard or hexagonal arrangement of alternating heights, the leaf balls of palms that are at the lower level will receive direct sunlight only during a limited duration near the middle of each day when the sun is approximately overhead, while receiving less light at other times of day due to being in the “shadow” of the leaf balls of adjacent palms that are at the higher level. Nevertheless, because coconut palms are typically grown in areas that receive abundant sunlight, in embodiments the “shorter” palms will receive sufficient sunlight to be able to thrive. In fact, in embodiments the increased “shade” that results from the dense planting of palms in a checkerboard or hexagonal arrangement, according to embodiments of the present invention, can help to protect the shorter palms from receiving too much sun, and thereby help them to retain water.

In other embodiments, coconut palms of the same variety, or of varieties having approximately the same heights, are planted on “terraced” land, such that the heights of the palms within each row are approximately the same, with each row of palms being elevated in height above the previous one. According to this approach, the palms within a row are planted about 20 feet from each other, while the terraces, and hence the columns of palms, can be spaced apart by as little as 10 feet, thereby doubling the yield per acre as compared to a simple grid of trees spaced apart by 20 feet. In these embodiments, the roots of each palm will grow outward to the edge of its terrace in one direction, while spreading unrestricted to the sides and inward in the other direction. This approach has the advantage of allowing the planting of only one variety of palm, while causing all of the palms to receive approximately the same amount of direct sunlight per day, especially of the rows of palms extend approximately in north-south directions.

Still other embodiments combine the “checkerboard” or “hexagonal” approach with the “terraced” approach, by alternating the heights of the leaf balls along each row, while successively raising the grade height between the rows, resulting in a “tilted” pattern of leaf balls that further reduces the spacing between the trees in the terraced or “tilt” direction, while, in some embodiments, at least partially equalizing the amount of light received by each of the palms during each day.

The present invention is a palm grove comprising a plurality of coconut palms, each of the coconut palms having a trunk and a leaf ball, said leaf ball extending in an approximately spherical pattern from the top of the trunk, the leaf balls of adjacent palms of the plurality of coconut palms being at differing heights, such that the leaf balls of adjacent palms of the plurality of coconut palms overlap each other with substantially no contact therebetween, a spacing between the trunks of the adjacent palms being less than a sum of radii of their leaf balls.

In embodiments, the adjacent palms of at least some of the plurality of palms are of differing palm varieties having differing heights.

In any of the above embodiments, underlying grades beneath at least some of the coconut palms can be of different heights, thereby causing or accentuating the height differences of the leaf balls of the adjacent palms of the plurality of coconut palms.

In any of the above embodiments, at least some of the coconut palms can be arranged in a checkerboard pattern in which the heights of the leaf balls of the adjacent coconut palms alternate in aligned rows and columns of the coconut palms, each of the coconut palms being surrounded by four nearest neighbor palms.

In any of the above embodiments, at least some of the coconut palms can be arranged in a staggered hexagonal pattern, each of the coconut palms being surrounded by six nearest neighbor palms.

In any of the above embodiments, at least some of the coconut palms can be arranged in a plurality of rows of the coconut palms, the palms of each of the rows all having leaf balls located at substantially equal heights, the heights of the leaf balls differing between adjacent rows of the plurality of rows.

In any of the above embodiments, at least some of the coconut palms can be arranged in a plurality of rows of the coconut palms, each of the rows extending along a terrace having a substantially uniform grade, adjacent terraces being of successively higher grades from a first terrace to a highest second terrace, differences between the heights of said grades establishing or enhancing the differences between the heights of the leaf balls of the adjacent rows. In some of these embodiments, the terraces continue at successively lower grades from the second terrace to a third terrace. And in some of these embodiments, the terraces extend substantially in a north-south direction.

In any of the above embodiments, at least some of the coconut palms can be arranged in rows in which the heights of the leaf balls of the adjacent coconut palms alternate in the row, a grade height of the rows being successively increased from a first row to a highest row. In some of these embodiments, the rows continue at successively lower grade heights from the highest row to a final row. In any of these embodiments, the rows can extend substantially in a north-south direction.

In any of the above embodiments, the spacing between at least some of the trunks can be between 10 and 16 feet in at least one of rows and columns of the palms.

In any of the above embodiments, at least some of the coconut palms can be spaced apart from each other in all directions by a spacing distance that is between 10 and 16 feet.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a palm grove of the prior art, in which palms are all of the same variety and height, and are spaced apart by approximately 20 feet;

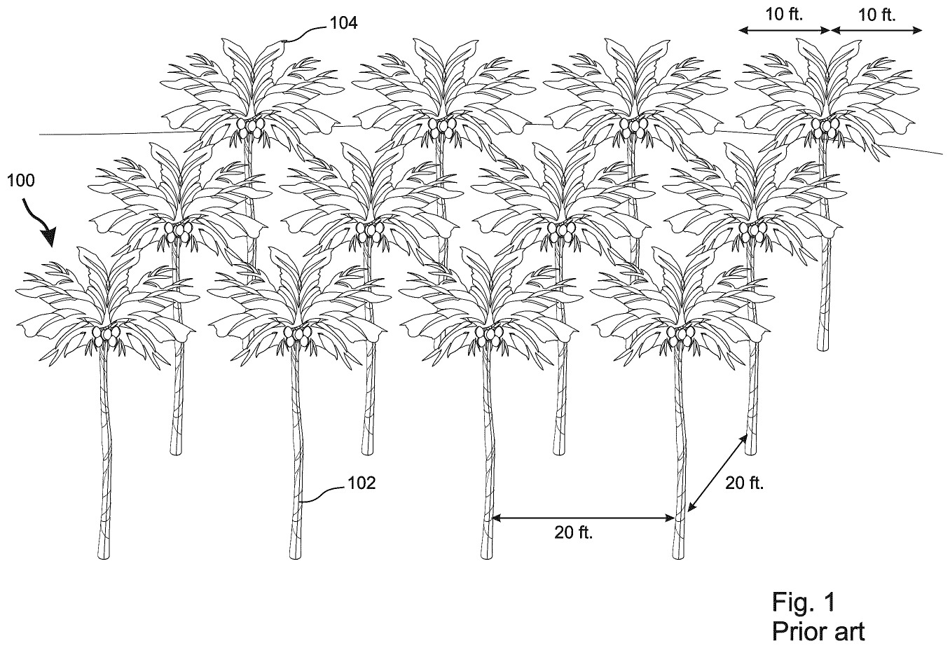

FIG. 2 is a side view of a single row of palms in an embodiment of the present invention in which the variety of the palms is alternated between a tall variety and a short variety, the palms being spaced apart by approximately 10 feet;

FIG. 3 is a perspective view of a grove of palms in an embodiment of the present invention in which the variety of the palms is alternated between a tall variety and a short variety, the palms being arranged in a checkerboard pattern of rows and columns and being spaced apart by approximately 16 feet;

FIG. 4A is a top view of the grove of FIG. 3, the leaf balls being represented as circles for simplicity of illustration;

FIG. 4B is a top view of a grove in an embodiment where the palms of alternating height are arranged hexagonally and spaced apart by approximately 12 feet, the leaf balls being represented as circles for simplicity of illustration;

FIG. 5A is a perspective view of a single row of palms according to an embodiment in which the grade at which the palms are planted is alternated by building up the ground beneath every other palm;

FIG. 5B is a perspective view of a single row of palms according to an embodiment in which the grade at which the palms are planted is alternated by excavating the ground beneath every other palm;

FIG. 6 is a side view of an embodiment of the present invention in which the palms are arranged in terraced rows, the palms in each row being approximately of the same height, while the heights of successive terraces increase to a maximum, and then decrease again;

FIG. 7 is a perspective view of the embodiment of FIG. 6, illustrating the morning exposure of the palm grove to sunlight; and

FIG. 8 is a perspective view of an embodiment where the palms are configured in a combined checkerboard and terraced arrangement, where the leaf balls are represented as spheres for ease of illustration.

### DETAILED DESCRIPTION

The present invention is a method of increasing the number of coconuts that can be harvested per acre of land from the palms of a coconut farm grove. The method includes planting coconut palms more closely together than 20 feet, while avoiding interference between the leaves of adjacent palms by varying the heights of the leaf balls at the tops of the palms.

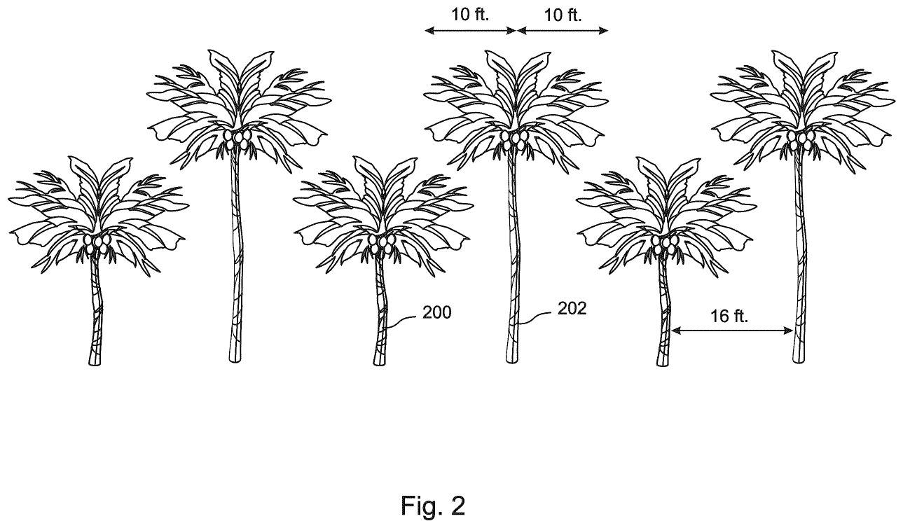

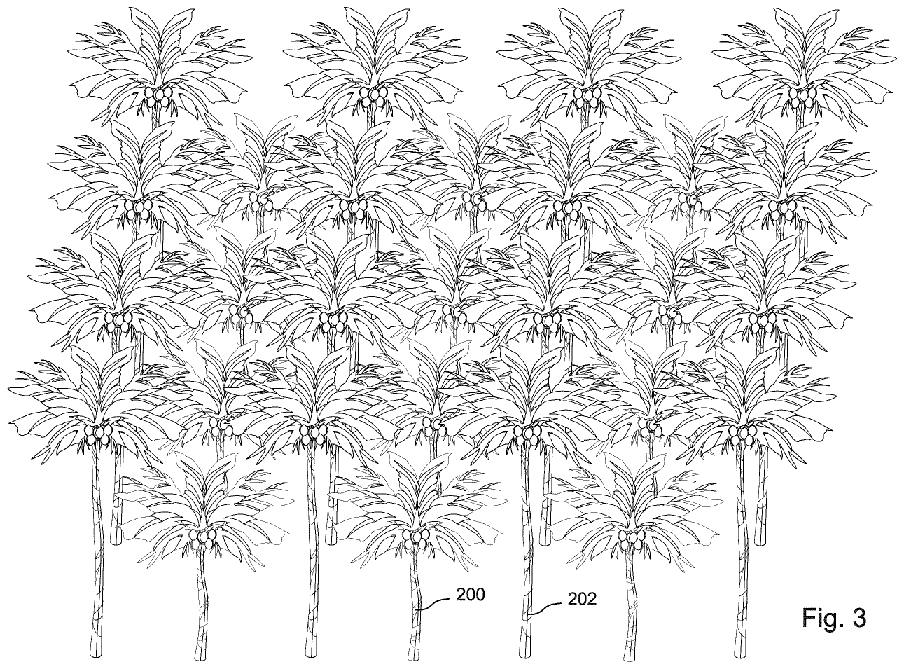

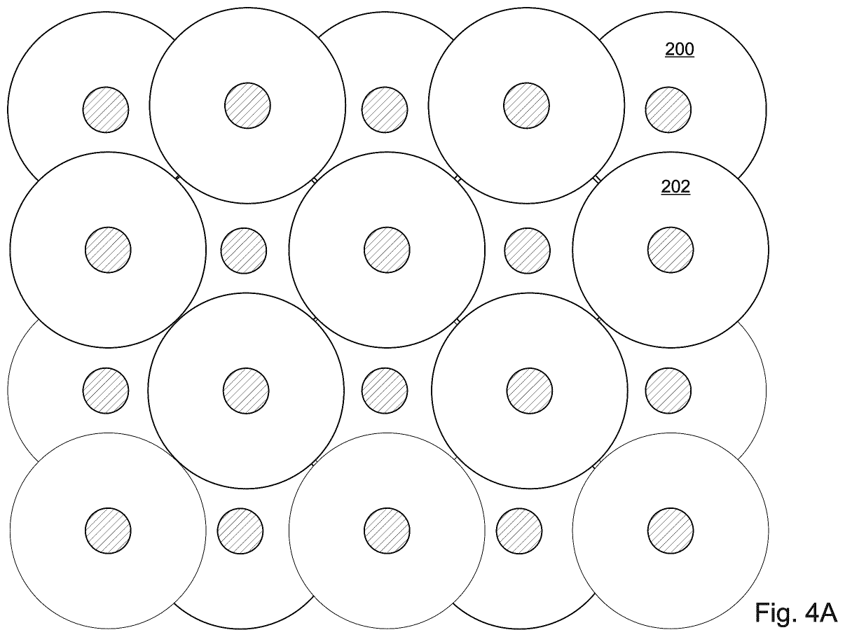

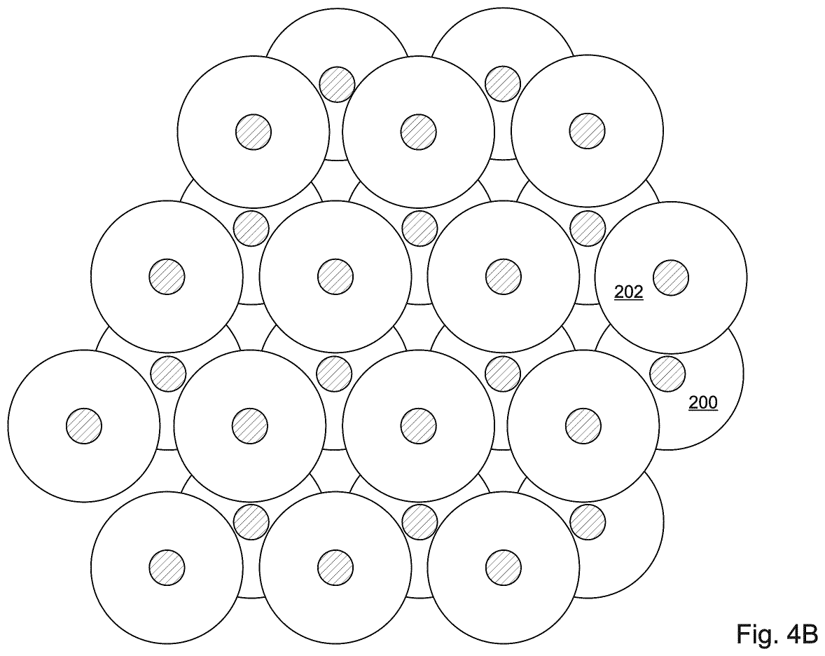

With reference to FIGS. 2-3, in embodiments the heights of adjacent palms are varied, at least in part, by alternating the varieties of the coconut palms that are planted. For example, with reference to FIG. 2, the leaf balls of “dwarf” varieties 200, such as Malaysian or Fiji dwarf palms, will generally be entirely beneath the leaves of adjacent “tall” varieties 202, such as Solomon Islands, Rennell, or Malaysian tall palms, thereby allowing them to be alternated in rows of palms 200, 202 with a spacing of less than 20 feet. FIG. 2 illustrates a single row of palms 200, 202 according to the illustrated embodiment, while FIG. 3 is a perspective view of an entire grove of the palms 200, 202 in a “checkerboard” configuration where the heights of the leaf balls are alternated in both the rows and columns of the grove, with each of the palms being surrounded by four nearest neighbor palms. FIG. 4A us a view from above of the grove of FIG. 3, where the upper portions of the palms 200, 202 are indicated as circles for clarity of illustration. In the illustrated embodiment, the spacing between palms 200, 202 is reduced from 20 feet to approximately 16 feet, allowing the leaf balls of the shorter palms 200 to nearly touch the trunks of the neighboring taller palms 202. This approach can increase the yield per acre by approximately 50%.

FIG. 4B is a top view similar to FIG. 4A of an embodiment in which the palms are arranged in staggered rows, forming a “hexagonal” pattern of palms, with each of the palms being surrounded by six nearest neighbor palms. It can be seen in FIG. 4B that the leaf balls of the adjacent palms 200, 202 overlap sufficiently for the leaf balls of the shorter palms 200 to nearly touch the trunks of the taller palms 202.

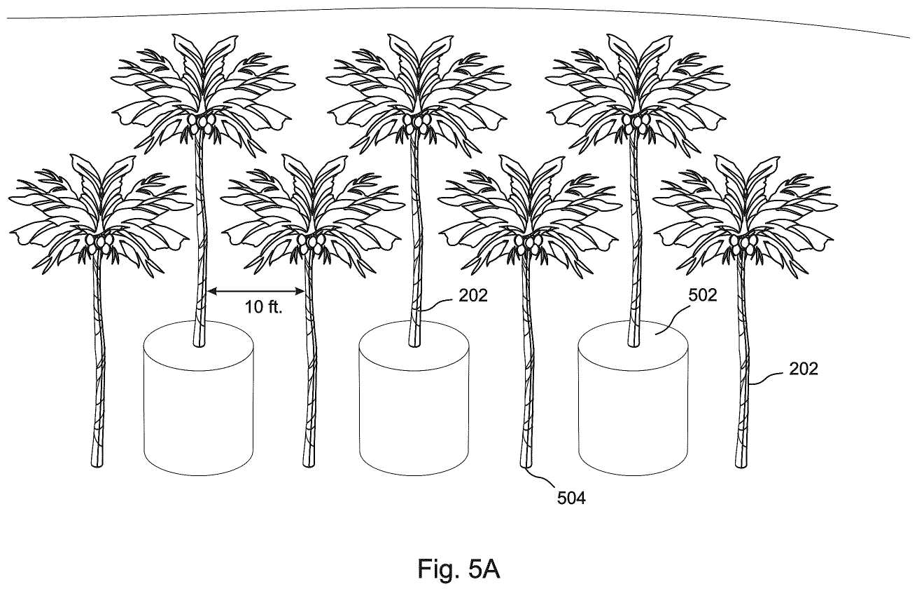

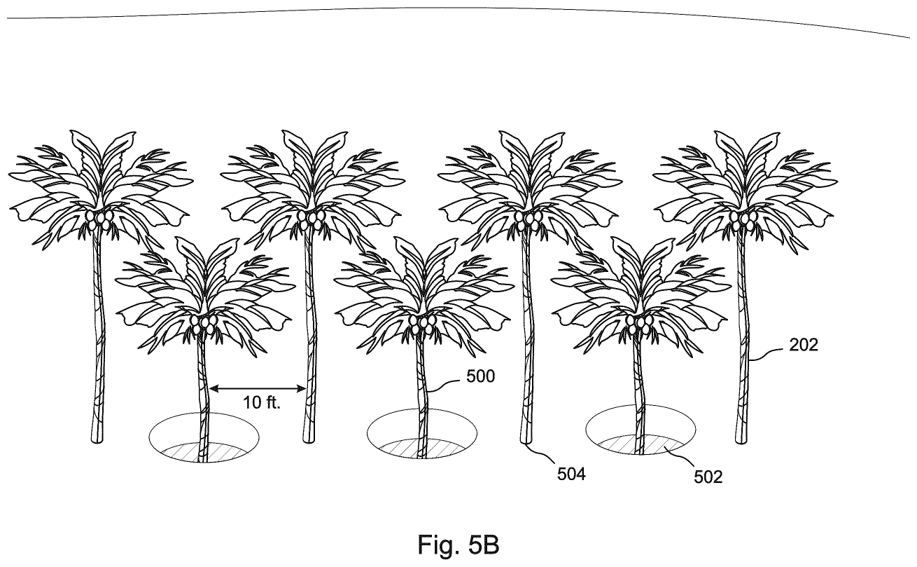

With reference to FIGS. 5A and 5B, in embodiments the heights of the leaf balls of the palms 202 are varied, at least in part, by grading the land on which at least some of the palms 202 are planted. This approach can be applied to a grove that includes only one variety of palm, or it can be used to further enhance the height differences between the leaf balls of adjacent palms 202, 500 of different varieties. For example, in the embodiment of FIG. 5A, interference between adjacent palms 202 of the same height is avoided by raising the grade 502 of the ground beneath every other palm 202 by about 10 feet.

With reference to FIG. 5B, grading the land on which the palms are planted can enable the leaf balls of palms of a tall variety 202 to fully overlap the leaf balls of adjacent hybrid palms 500 having an intermediate height between the tall 202 and dwarf 200 palm varieties. Interference between palms of the same height can be avoided by providing sufficient changes to the grade heights beneath adjacent palms. Varying or alternating the grade of adjacent palms can also have the benefit of avoiding interference between their roots. For example, with continuing reference to FIG. 5B, if every other palm 500 in a row is a hybrid palm planted in a recessed location 502 that has been excavated to a level that is about five feet below the planting grade 504 of adjacent “tall” varieties 202, interference between the leaves of adjacent palms 202, 500 can be avoided, while at the same time causing the roots of the hybrid palms 500 to extend at a depth that is well below the roots of the tall palms 202.

Coconut palms are generally grown in areas of intense sunlight. Accordingly, with reference again to FIGS. 4A and 4B, in some embodiments where the palms are planted in a “checkerboard” or “hexagonal” pattern, with the heights of the palms 200, 202 being alternated in each row and also between adjacent rows, the palms having their leaf balls at the lower elevation 200 receive sufficient sunlight to meet their needs, even though they receive direct sunlight only during a limited duration near the middle of each day when the sun is approximately overhead, while receiving less light at other times of day due to being in the partial “shadow” of the adjacent, higher palms 202. If the taller palms 202 are of a variety that is more resistant to intense light and heat, this may even help to protect the shorter palms 200 from over exposure to the sun.

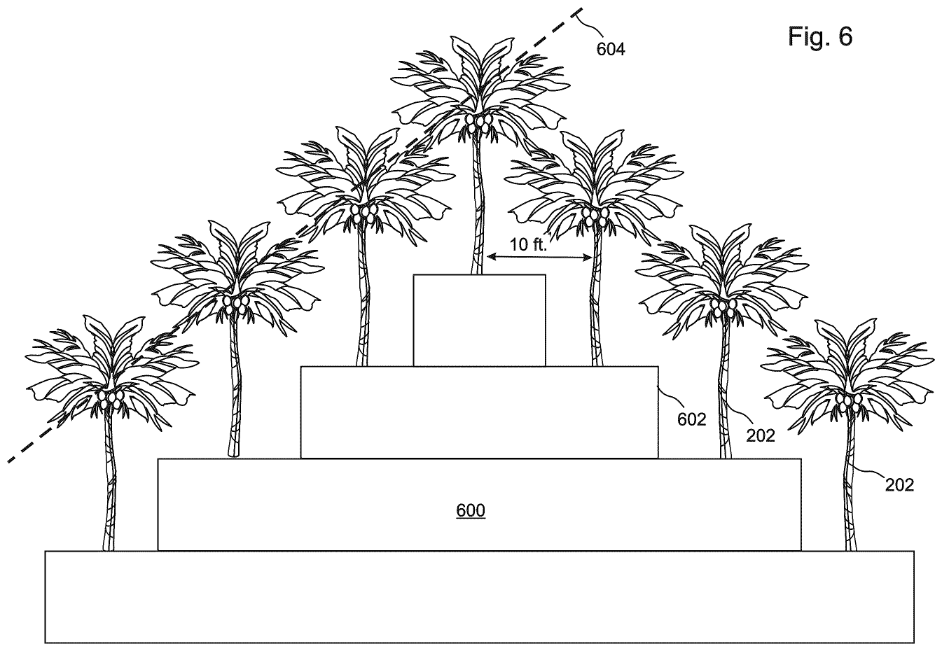

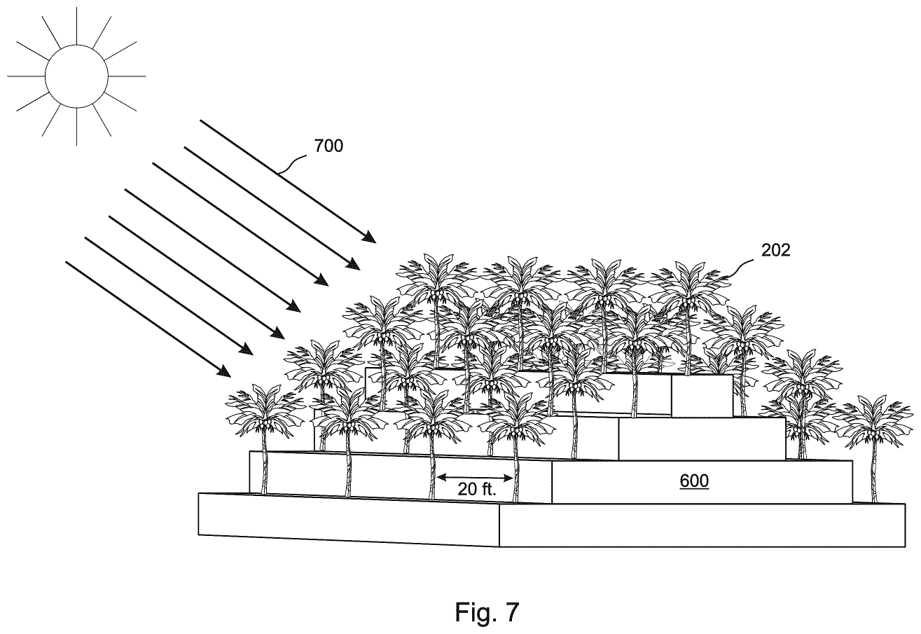

With reference to FIGS. 6 and 7, in other embodiments coconut palms 202 of the same variety, or of varieties having approximately the same heights, are planted on “terraced” land 600, such that each row of palms 202 is elevated above the next. According to this approach, the palms 202 within a row are planted at a uniform grade about 20 feet from each other. However, the terraced rows can be within 10 to 12 feet of each other, thereby nearly doubling the coconut yield per acre. In these embodiments, the roots of each palm 202 will grow outward to the edge 602 of its terrace 600 in one direction, while spreading unrestricted to the sides and inward in the other direction, while the terracing ensures that the roots from adjacent terraces do not interfere with each other. The approach of FIG. 4 has the advantages of nearly doubling the yield per acre, while allowing the planting of only one variety of palm 202, and causing all of the palms 202 to receive approximately the same amount of direct sunlight 700 per day, especially when the terraces extend approximately in a north-south direction.

The effect of “terracing” the palms, as illustrated in FIG. 6, is essentially to arrange the leaf balls in a tilted plane 604. In the example of FIG. 6, the leaf balls are separated from each other in the tilted plane 604 by approximately 20 feet. However, due to the “tilt” of the plane 604, the horizontal spacing between the trunks in the “terraced” direction is much less than 20 feet.

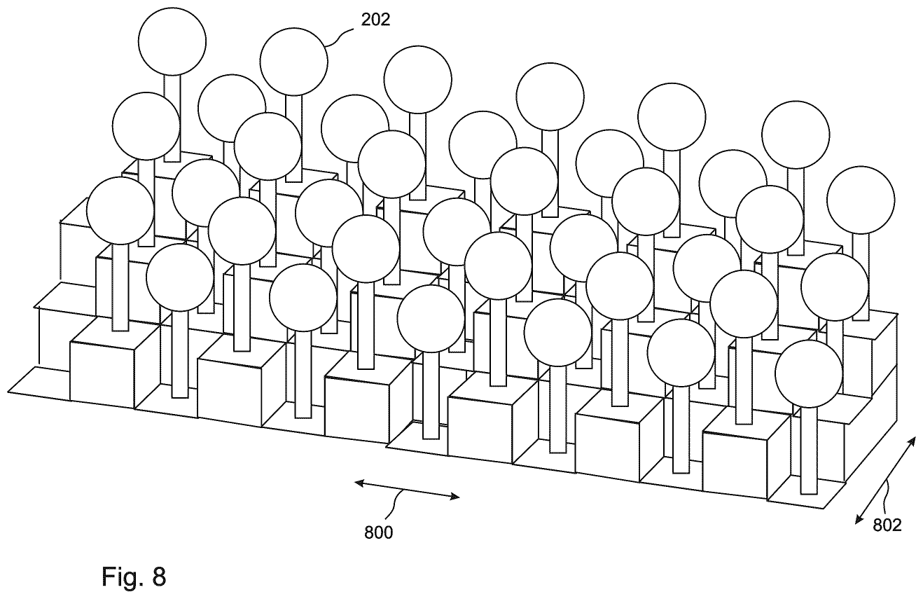

With reference to FIG. 8, embodiments combine the “checkerboard” or “hexagonal” approach with the “terraced” approach by alternating the heights of the leaf balls along each row 800, while successively raising the grade height of each row in the terraced direction 802, thereby tilting the “plane” 604 of the checkerboard or staggered hexagon pattern, and enabling the spacing between the trunks of the palms 202 to be reduced. In some embodiments, for example by terracing a “hexagonal” pattern of palms, the horizontal spacing between the trunks can be reduced to less than 10 feet in the terraced direction 802.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A palm grove comprising a plurality of coconut palms, each of the coconut palms having a trunk and a leaf ball, said leaf ball extending in an approximately spherical pattern from the top of the trunk, the leaf balls of adjacent palms of the plurality of coconut palms being at differing heights, such that the leaf balls of adjacent palms of the plurality of coconut palms overlap each other with substantially no contact therebetween, a spacing between the trunks of the adjacent palms being less than a sum of radii of their leaf balls.

2. The palm grove of claim 1, wherein the adjacent palms of the plurality of palms are of differing palm varieties having differing heights.

3. The palm grove of claim 1, wherein underlying grades beneath the coconut palms are of different heights, thereby causing or accentuating the height differences of the leaf balls of the adjacent palms of the plurality of coconut palms.

4. The palm grove of claim 1, wherein the coconut palms are arranged in a checkerboard pattern in which the heights of the leaf balls of the adjacent coconut palms alternate in aligned rows and columns of the coconut palms, each of the coconut palms being surrounded by four nearest neighbor palms.

5. The palm grove of claim 1, wherein the coconut palms are arranged in a staggered hexagonal pattern, each of the coconut palms being surrounded by six nearest neighbor palms.

6. The palm grove of claim 1, wherein the coconut palms are arranged in a plurality of rows of the coconut palms, the palms of each of the rows all having leaf balls located at substantially equal heights, the heights of the leaf balls differing between adjacent rows of the plurality of rows.

7. The palm grove of claim 1, wherein the coconut palms are arranged in a plurality of rows of the coconut palms, each of the rows extending along a terrace having a substantially uniform grade, adjacent terraces being of successively higher grades from a first terrace to a highest second terrace, differences between the heights of said grades establishing or enhancing the differences between the heights of the leaf balls of the adjacent rows.

8. The palm grove of claim 7, wherein the terraces continue at successively lower grades from the second terrace to a third terrace.

9. The palm grove of claim 8, wherein the terraces extend substantially in a north-south direction.

10. The palm grove of claim 1, wherein the coconut palms are arranged in rows in which the heights of the leaf balls of the adjacent coconut palms alternate in the row, a grade height of the rows being successively increased from a first row to a highest row.

11. The palm grove of claim 10, wherein the rows continue at successively lower grade heights from the highest row to a final row.

12. The palm grove of claim 10, wherein the rows extend substantially in a north-south direction.

13. The palm grove of claim 1, wherein the spacing between the trunks is between 10 and 16 feet in at least one of rows and columns of the palms.

14. The palm grove of claim 1, wherein the coconut palms are spaced apart from each other in all directions by a spacing distance that is between 10 and 16 feet.
